(19) United States
(12) Patent Application Publication
(10) Pub. No.: US 2012/0051690 A1
(43) Pub. Date: Mar. 1, 2012

(54) OPTICAL WAVEGUIDE MODULE FOR TOUCH PANEL AND METHOD OF MANUFACTURING SAME

(75) Inventors: Ryusuke Naito, Osaka (JP); Naoki Shibata, Osaka (JP)

(73) Assignee: NITTO DENKO CORPORATION, Osaka (JP)

(21) Appl. No.: 13/213,708

(22) Filed: Aug. 19, 2011

Related U.S. Application Data
(60) Provisional application No. 61/382,256, filed on Sep. 13, 2010.

(30) Foreign Application Priority Data
Aug. 26, 2010 (JP) 2010-189566

(51) Int. Cl. G02B 6/122; G02B 6/13

(52) U.S. Cl. 385/14; 427/163.2

(57) ABSTRACT

An optical waveguide module for a touch panel is provided which achieves the reduction in thickness, and a method of manufacturing the same. The optical waveguide module includes an optical waveguide unit for placement along the periphery of a display screen of a display of a touch panel, and a substrate unit coupled to an outer edge portion of the optical waveguide unit so as to be in orthogonal relation to the optical waveguide unit. The substrate unit includes a substrate bent toward the optical waveguide unit, and the bend of the substrate in that state has a distal end serving as a connecting portion to an electrical interconnect line. An over cladding layer includes a slot provided in a surface thereof and extending along the periphery of the display screen of the display. The electrical interconnect line is put in the slot.

### RELATED APPLICATIONS

This application claims the benefit of U.S. Provisional Application No. 61/382,256 filed on Sep. 13, 2010, which is hereby incorporated by reference.

### BACKGROUND OF THE INVENTION

1. Field of the Invention

The present invention relates to an optical waveguide module for a touch panel which is used as a detection means for detecting a finger touch position and the like in a touch panel, and a method of manufacturing the same.

2. Description of the Related Art

A touch panel is an input device for operating an apparatus by directly touching a display screen of a liquid crystal display and the like with a finger, a purpose-built stylus and the like. The touch panel includes a display that displays operation details and the like, and a detection means that detects the position (coordinates) of a portion of the display screen of the display touched with the finger and the like. Information indicating the touch position detected by the detection means is sent in the form of a signal to the apparatus, which in turn performs an operation and the like displayed on the touch position. Examples of the apparatus employing such a touch panel include ATMs in banking facilities, ticket vending machines in stations, and portable game machines

A detection means employing an optical waveguide module has been proposed as the detection means that detects the finger touch position and the like in the aforementioned touch panel (see for example, JP-A-2010-15247). Specifically, as shown in a sectional side view of FIG. 12, the touch panel includes a light-emitting optical waveguide unit A₀ provided on one side of a display screen of a display 51 of a rectangular plan configuration, and a light-receiving optical waveguide unit B₀ provided on the other side of the display screen of the aforementioned display 51. Also, a substrate unit C with a light-emitting element 71 mounted therein is coupled to an outer edge portion of the aforementioned light-emitting optical waveguide unit A₀ so as to be in orthogonal relation to the aforementioned optical waveguide unit A₀, and a substrate unit D with a light-receiving element 72 mounted therein is coupled to an outer edge portion of the aforementioned light-receiving optical waveguide unit B₀ so as to be in orthogonal relation to the aforementioned optical waveguide unit B₀. The aforementioned light-emitting optical waveguide unit A₀ divides a light beam emitted from the aforementioned light-emitting element 71 into multiple light beams. The optical waveguide unit A₀ includes a light-emitting section which emits the aforementioned multiple light beams S parallel to the display screen of the display 51 toward the other side of the display screen. The aforementioned light-receiving optical waveguide unit B₀ includes a light-receiving section which receives the emitted light beams S. In this manner, the optical waveguide module for a touch panel including the aforementioned optical waveguide units A₀ and B₀ and the substrate units C and D causes the emitted light beams S to travel in a lattice form over the display screen of the display 51. When a portion of the display screen of the display 51 is touched with a finger in this state, the finger blocks some of the emitted light beams S. The light-receiving element 72 in the aforementioned light-receiving optical waveguide unit B₀ senses a light blocked portion to thereby detect the position (coordinates) of the portion touched with the finger. In FIG. 12, the reference numeral 61 designates abase, 62 designates an under cladding layer, 63 designates cores, and 64 designates an over cladding layer.

In the substrate units C and D, the aforementioned light-emitting element 71 and the light-receiving element 72 are mounted on respective substrates 73. An electrical interconnect line 74 for the aforementioned light-emitting element, and an electrical interconnect line 75 for the aforementioned light-receiving element are connected to lower end portions of the respective substrates 73. The electrical interconnect lines 74 and 75 extend in an opposite direction (in FIG. 12, a downward direction) from the orientation of the display screen of the aforementioned display 51, and are connected to a motherboard (not shown) or the like for transmitting a signal to the aforementioned light-emitting element 71 and for receiving a signal from the aforementioned light-receiving element 72 to process the signal.

There is a need for the reduction in the thickness of the aforementioned optical waveguide module for a touch panel. In the optical waveguide module for a touch panel, however, the aforementioned substrate units C and D are coupled to the aforementioned optical waveguide units A₀ and B₀ so as to be in orthogonal relation thereto. Additionally, the aforementioned substrate units C and D include the downwardly extending electrical interconnect lines 74 and 75, and it is necessary that the substrates 73 have connecting portions to the electrical interconnect lines 74 and 75. For these reasons, the substrate units C and D are increased in height (thickness). The entire optical waveguide module for a touch panel is accordingly increased in thickness. The aforementioned optical waveguide module for a touch panel still has room for improvement in this regard.

### SUMMARY OF THE INVENTION

An optical waveguide module for a touch panel is provided which achieves the reduction in thickness, and a method of manufacturing the same.

A first aspect is an optical waveguide module for a touch panel, which comprises: an optical waveguide unit for placement along the periphery of a display screen of a display of a touch panel; and a substrate unit coupled to an outer edge portion of the optical waveguide unit so as to be in orthogonal relation to the optical waveguide unit, the optical waveguide unit including an under cladding layer, cores provided on a surface of the under cladding layer, and an over cladding layer provided to cover the cores, the substrate unit including a substrate, an optical element mounted on a surface of the substrate, and an electrical interconnect line for an optical element connected to the substrate, the substrate of the substrate unit being bent toward the optical waveguide unit, the bend of the substrate in that state having a distal end serving as a connecting portion to the electrical interconnect line, the over cladding layer including a slot provided in a surface thereof and extending along the periphery of the display screen of the display, the electrical interconnect line being put in the slot provided in the surface of the over cladding layer.

Also, a second aspect is a method of manufacturing an optical waveguide module for a touch panel, which comprises the steps of: producing an optical waveguide unit; producing a substrate unit separately from the optical waveguide unit; and coupling the substrate unit to an outer edge portion of the optical waveguide unit, the step of producing the optical waveguide unit including the substeps of forming cores on a surface of an under cladding layer, and then forming a slot for receiving an electrical interconnect line of the substrate unit therein in a surface of an over cladding layer by molding at the same time as the formation of the over cladding layer covering the cores, the step of coupling the substrate unit to the optical waveguide unit being performed, while a substrate of the substrate unit is bent toward the optical waveguide unit and the electrical interconnect line connected to a distal end of the bend of the substrate is put in the slot.

Further, a third aspect is a method of manufacturing an optical waveguide module for a touch panel, which comprises the steps of: producing an optical waveguide unit; producing a substrate unit separately from the optical waveguide unit; and coupling the substrate unit to an outer edge portion of the optical waveguide unit, the step of producing the optical waveguide unit including the substeps of forming cores on a surface of an under cladding layer, forming an over cladding layer covering the cores, and then removing part of a surface of the over cladding layer to form a slot for receiving an electrical interconnect line of the substrate unit therein, the step of coupling the substrate unit to the optical waveguide unit being performed, while a substrate of the substrate unit is bent toward the optical waveguide unit and the electrical interconnect line connected to a distal end of the bend of the substrate is put in the slot.

The term “slot” is not limited to a slot having both lefthand and righthand side walls extending along the length thereof, but shall be meant to include a slot with one of the lefthand and righthand side walls dispensed with. The one side wall dispensed with is a side wall corresponding to an outer periphery (where the display screen of the display is absent) in the optical waveguide unit disposed along the periphery of the display screen of the display of a touch panel.

The thickness of the optical waveguide module for a touch panel is reduced. A predetermined portion of an upper surface of the over cladding layer of the optical waveguide unit is used. It has been common technical practice that no processing is added to that portion because there is apprehension that the use of that portion exerts adverse effects on the propagation of light beams in the optical waveguide unit. The reduction in the thickness of the optical waveguide module for a touch panel is achieved by forming the aforementioned slot in the surface of the over cladding layer and putting the electrical interconnect line of the substrate unit in the slot without adverse effects on the propagation of light beams.

The optical waveguide module for a touch panel (in the first aspect) is reduced in thickness, because the substrate of the substrate unit is bent toward the aforementioned optical waveguide unit when the substrate unit is coupled to the optical waveguide unit. Additionally, the slot is formed in the surface of the over cladding layer of the optical waveguide unit, and the electrical interconnect line of the aforementioned substrate unit is put in the slot. Unlike conventional optical waveguide modules for a touch panel, the optical waveguide module includes the aforementioned electrical interconnect line not extending downwardly. Thus, the optical waveguide module is much reduced in thickness, as compared with conventional ones.

Also, in the method of manufacturing an optical waveguide module for a touch panel (in the second and third aspects), the slot for receiving the electrical interconnect line of the substrate unit therein is formed in the surface of the over cladding layer. Then, when the substrate unit is coupled to the optical waveguide unit, the substrate of the substrate unit is bent toward the optical waveguide unit, and the electrical interconnect line of the substrate unit is put in the aforementioned slot. This achieves the manufacture of an optical waveguide module for a touch panel which is much reduced in thickness as mentioned above.

Preferably, the slot has a depth of not less than 0.1 mm. In such a case, the volume for receiving the electrical interconnect line is increased. This reduces or eliminates the amount of protrusion of the electrical interconnect line from the aforementioned slot to further reduce the thickness of the optical waveguide module for a touch panel.

Preferably, an inner edge portion of the over cladding layer for positioning on the periphery of the display screen of the display is in the form of a lens portion having an outwardly-bulging arcuately curved surface as seen in vertical sectional view. In such a case, even when the lens portion which is required to be high is formed, the reduction in the thickness of the optical waveguide module for a touch panel is achieved by bending the substrate of the substrate unit toward the optical waveguide unit and putting the electrical interconnect line of the substrate unit in the aforementioned slot.

### BRIEF DESCRIPTION OF THE DRAWINGS

FIG. 1A is a plan view schematically showing an optical waveguide module for a touch panel according to one preferred embodiment.

FIG. 1B is a sectional view, on an enlarged scale, of principal parts taken along the line X1-X1 of FIG. 1A.

FIG. 1C is a sectional view, on an enlarged scale, taken along the line Y1-Y1 of FIG. 1A.

FIG. 2A is a plan view schematically showing an optical waveguide unit constituting the aforementioned optical waveguide module for a touch-panel.

FIG. 2B is a sectional view, on an enlarged scale, of principal parts taken along the line X2-X2 of FIG. 2A.

FIG. 2C is a sectional view, on an enlarged scale, taken along the line Y2-Y2 of FIG. 2A.

FIG. 3 is a front view schematically showing a substrate unit constituting the aforementioned optical waveguide module for a touch panel.

FIG. 4 is a side view of principal parts as seen in the direction of the arrow Z of FIG. 1A.

FIGS. 5A to 5D and FIGS. 6A to 6C are illustrations schematically showing a method of producing the aforementioned optical waveguide unit.

FIGS. 7A to 7C and FIGS. 8A and 8B are illustrations schematically showing a method of producing the aforementioned substrate unit.

FIG. 9 is an illustration schematically showing a method of coupling the aforementioned optical waveguide unit and the aforementioned substrate unit to each other.

FIGS. 10A to 10K are sectional views schematically showing modifications of the aforementioned optical waveguide unit.

FIGS. 11A and 11B are sectional views schematically showing inventive examples of the aforementioned optical waveguide unit.

FIG. 12 is a sectional view schematically showing a touch panel including a conventional optical waveguide module.

### DETAILED DESCRIPTION OF THE INVENTION

Next, a preferred embodiment of the present invention will now be described in detail with reference to the drawings.

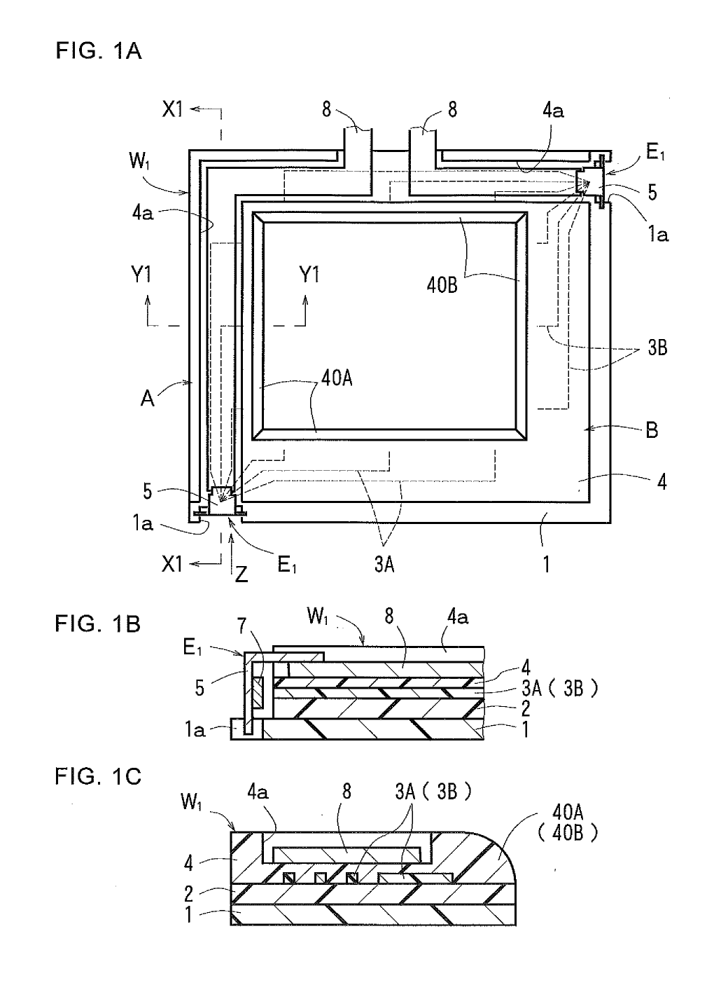

FIGS. 1A to 1C show an optical waveguide module for a touch panel according to one preferred embodiment. As shown in FIG. 1A, the optical waveguide module for a touch panel according to this preferred embodiment includes an optical waveguide unit W₁ provided in the form of a rectangular frame as seen in plan view, and two substrate units E₁ coupled to diagonally opposed outer edge portions of this optical waveguide unit W₁ so as to be in orthogonal relation to the aforementioned optical waveguide unit W₁. As shown in FIG. 1B, which is a sectional view taken along the line each of the aforementioned substrate units E₁ is bent toward the aforementioned optical waveguide unit W₁. In that state, an electrical interconnect line 8 extends from a distal end of the bend of each of the substrate units E₁. Also, slots 4a are provided in part of the surface of an over cladding layer 4 of the aforementioned optical waveguide unit W₁ where the aforementioned electrical interconnect lines 8 are positioned, and extend along the sides of the aforementioned frame. As shown in FIG. 1C, which is a sectional view taken along the line Y1-Y1, the aforementioned electrical interconnect lines 8 are received in the aforementioned slots 4a. Such a structure achieves the reduction in the thickness of the optical waveguide module for a touch panel.

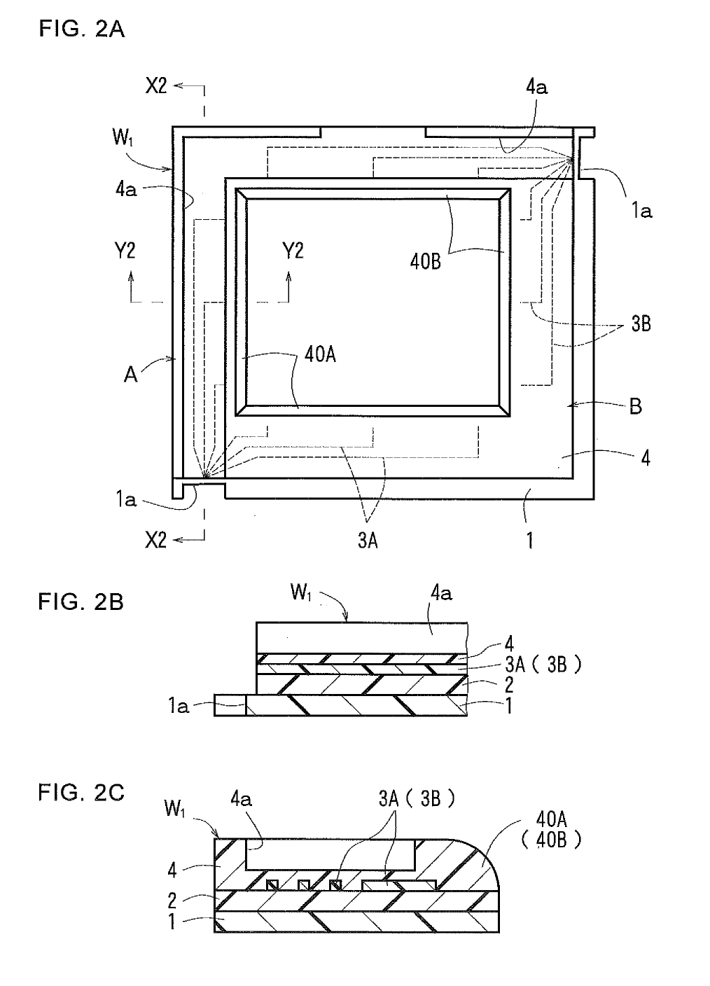

The components will be described in further detail. As shown in FIGS. 2A to 2C, the aforementioned optical waveguide unit W₁ is bonded to a surface of a base 1. One L-shaped section constituting the rectangular frame of the optical waveguide unit W₁ is a light-emitting optical waveguide section A, and the other L-shaped section is a light-receiving optical waveguide section B. The aforementioned optical waveguide unit W₁ includes an under cladding layer 2 in the form of a rectangular frame, and a plurality of cores 3A and 3B serving as a passageway for light and provided on predetermined portions of a surface of the under cladding layer 2. The cores 3A and 3B are patterned to extend from coupling portions of the substrate units E₁ (with reference to FIGS. 1A to 1C) to inner end edges of the respective L-shaped sections and to be arranged in a parallel, equally spaced relationship. Further, the over cladding layer 4 is provided on the surface of the under cladding layer 2 so as to cover the cores 3A and 3B. In this preferred embodiment, edges of the over cladding layer 4 are extended to form lens portions 40A and 40B which cover the end surfaces of the light-emitting and light-receiving cores 3A and 3B lying at the inner end edges of the aforementioned L-shaped sections. As shown in FIG. 2C, which is a sectional view taken along the line Y2-Y2, the aforementioned lens portions 40A and 40B have respective lens surfaces that are arcuately curved surfaces as seen in vertical sectional view.

In FIG. 2A, the cores 3A and 3B are indicated by broken lines, and the thickness of the broken lines indicates the thickness of the cores 3A and 3B. Also, in FIG. 2A, the number of cores 3A and 3B are shown as abbreviated. Further, the light-emitting and light-receiving components, which are identical in structure with each other, are shown by the same drawing in FIGS. 2B and 2C. In FIGS. 2A and 2B, the reference character 1a designates notches provided in the aforementioned base 1 for insertion of a lower end portion N (with reference to FIG. 4) of each of the substrate units E₁ therein during the coupling of each the substrate units E₁ (with reference to FIGS. 1A and 1B).

As shown in FIG. 2C, the aforementioned slots 4a for receiving the aforementioned electrical interconnect lines are formed except where the aforementioned lens portions 40A and 40B are provided. In this preferred embodiment, the aforementioned slots 4a are of a generally U-shaped cross-sectional configuration having a flat bottom surface and wall surfaces orthogonal to the bottom surface on opposite sides of the bottom surface. It is preferable that the bottom surface of the aforementioned slots 4a is at a vertical position 0.01 mm or more above the top surfaces of the cores 3A and 3B from the viewpoint of fulfilling the function of the optical waveguide. It is preferable that the aforementioned slots 4a have a depth of 1.0 mm or more from the viewpoint of increasing the volume for receiving the electrical interconnect lines 8. It should be noted that the height of the aforementioned lens portions 40A and 40B (the height as measured from the surface of the under cladding layer 2) is preferably 0.5 mm or more from the viewpoint of fulfilling a lens function, more preferably in the range of 0.5 to 2.0 mm from the viewpoint of the reduction in thickness.

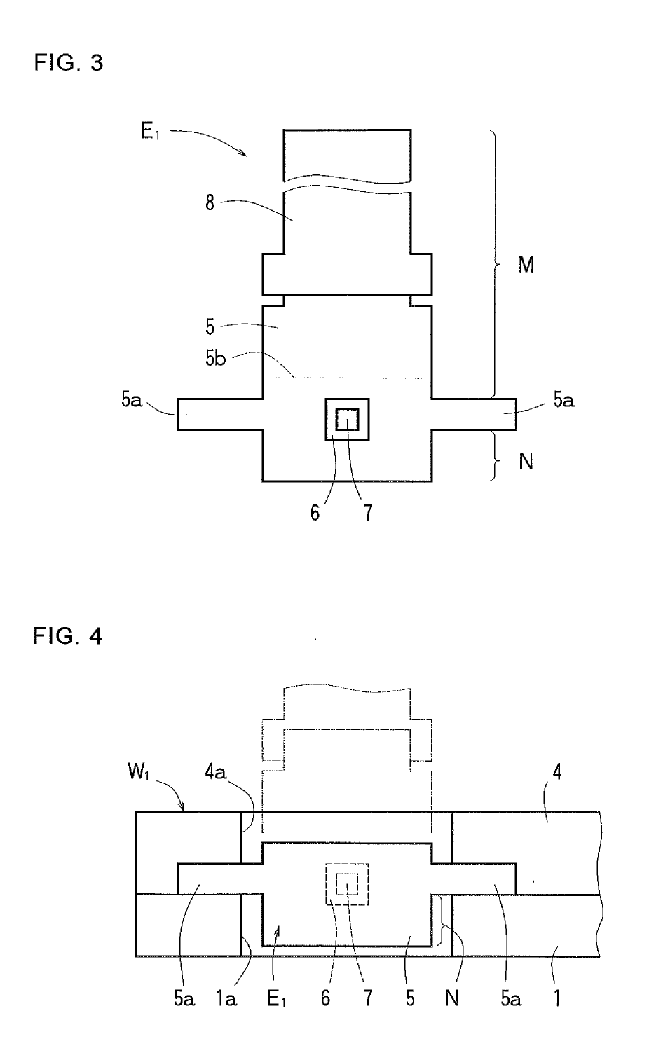

On the other hand, each of the aforementioned substrate units E₁ before being coupled to the aforementioned optical waveguide unit W₁, as shown in FIG. 3, includes a substrate 5 in the form of a flat plate (not bent), an insulation layer (not shown) formed on a predetermined region of the surface of this substrate 5, an electric circuit (not shown) and an optical element mounting pad 6 formed on a predetermined region of the surface of this insulation layer, an optical element 7 mounted on this optical element mounting pad 6, a sealing resin (not shown) for sealing this optical element 7, and an electrical interconnect line 8 for an optical element which is connected to an upper end portion of the aforementioned substrate 5. In this preferred embodiment, positioning plate portions 5a for the positioning on the surface of the aforementioned base 1 is provided on opposite sides of the aforementioned substrate 5 so as to protrude in the direction of the width of the substrate 5 (leftwardly and rightwardly as seen in FIG. 3). The aforementioned electric circuit is provided for conduction of electricity between the connecting portion of the aforementioned electrical interconnect line 8 and the optical element 7. Examples of the aforementioned electrical interconnect line 8 include a flexible printed board, and a lead wire. The optical element 7 in one of the two substrate units E₁ coupled to the two portions of the aforementioned optical waveguide unit W₁ which is coupled to the light-emitting optical waveguide section A is a light-emitting element, and the optical element 7 in the other substrate unit E₁ which is connected to the light-receiving optical waveguide section B is a light-receiving element.

In the aforementioned optical waveguide module for a touch panel, the substrate 5 in the substrate unit E₁ shown in FIG. 3 is bent at a dash-and-dot line 5b above the optical element 7. Then, the lower end portion N of the aforementioned substrate unit E₁ is inserted (inserted toward the back surface of the paper as seen in FIG. 2A) into one of the aforementioned notches la of the base 1 of the optical waveguide unit W₁ shown in FIGS. 2A and 2B. At the same time, the lower end edges of the positioning plate portions 5a are brought into abutment with the surface of the portions of the base 1 on the lefthand and righthand sides of the one of the notches 1a. The aforementioned bends M are put in the slots 4a, respectively, and configured as shown in FIG. 1A. FIG. 4 is a side view of the principal parts in that state as seen in the direction of the arrow Z of FIG. 1A. Portions of the aforementioned substrate units E₁ which are inserted in the aforementioned notches 1a and which are in abutment with the surface of the base 1 are fixed with an adhesive.

In this preferred embodiment, as shown in FIG. 1A, the electrical interconnect lines 8 of the aforementioned two substrate units E₁ are collected to one location on the surface of the over cladding layer 4, and are taken therefrom to the outside of the aforementioned optical waveguide unit W₁. Thus, part of the side walls of the aforementioned slots 4a corresponding to the outer periphery of the optical waveguide unit W₁ (on the opposite side from the lens portions 40A and 40B) is partially removed in the location where the electrical interconnect lines 8 are taken to the outside.

The aforementioned optical waveguide module for a touch panel is manufactured by undergoing the process steps (1) to (3) to be described below.

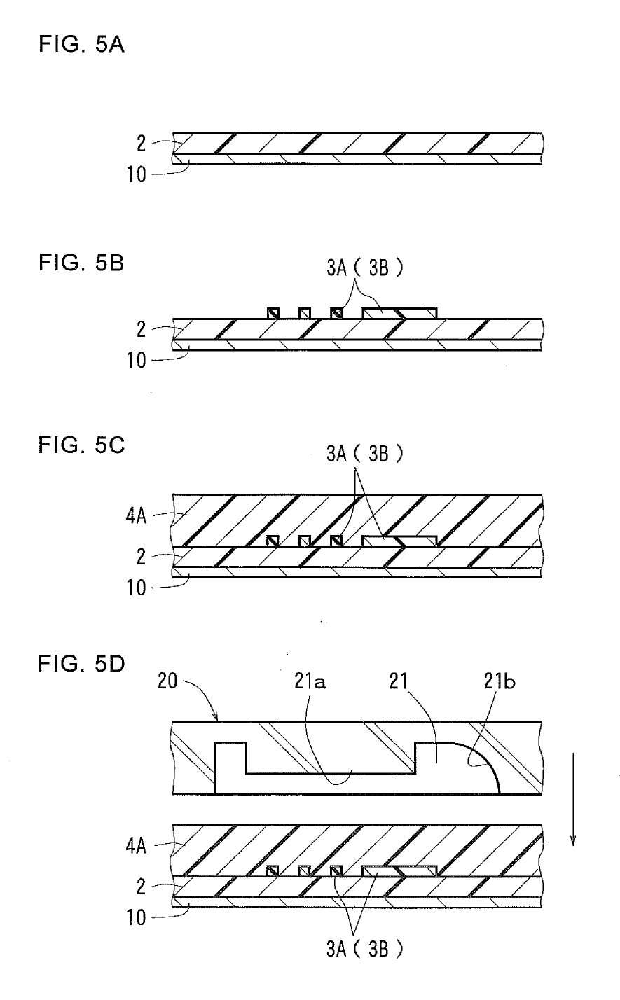

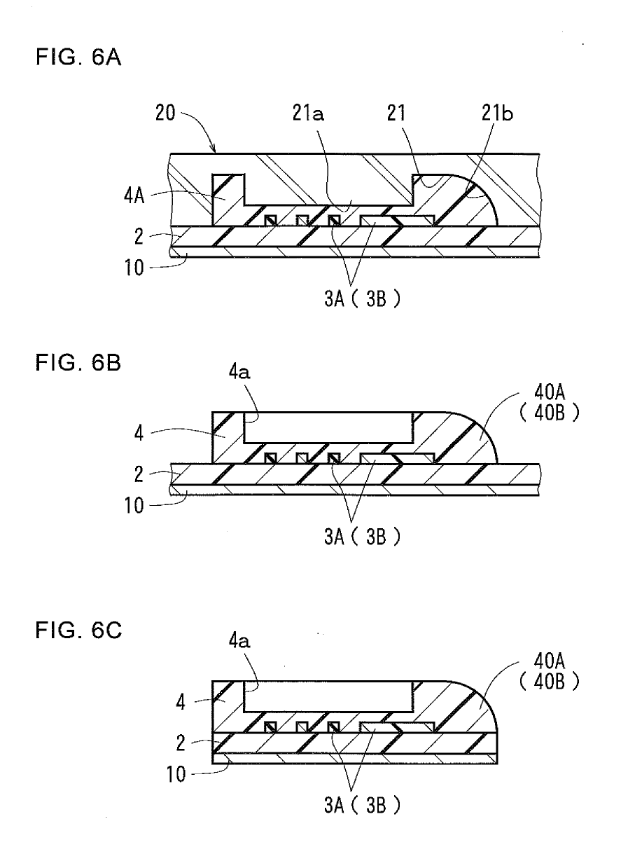

(1) The step of producing the aforethentioned optical waveguide unit W₁ (with reference to FIGS. 5A to 5D and FIGS. 6A to 6C). It should be noted that FIGS. 5A to 5D and FIGS. 6A to 6C for illustrating step (1) are views corresponding to the sectional view shown in FIG. 2C.

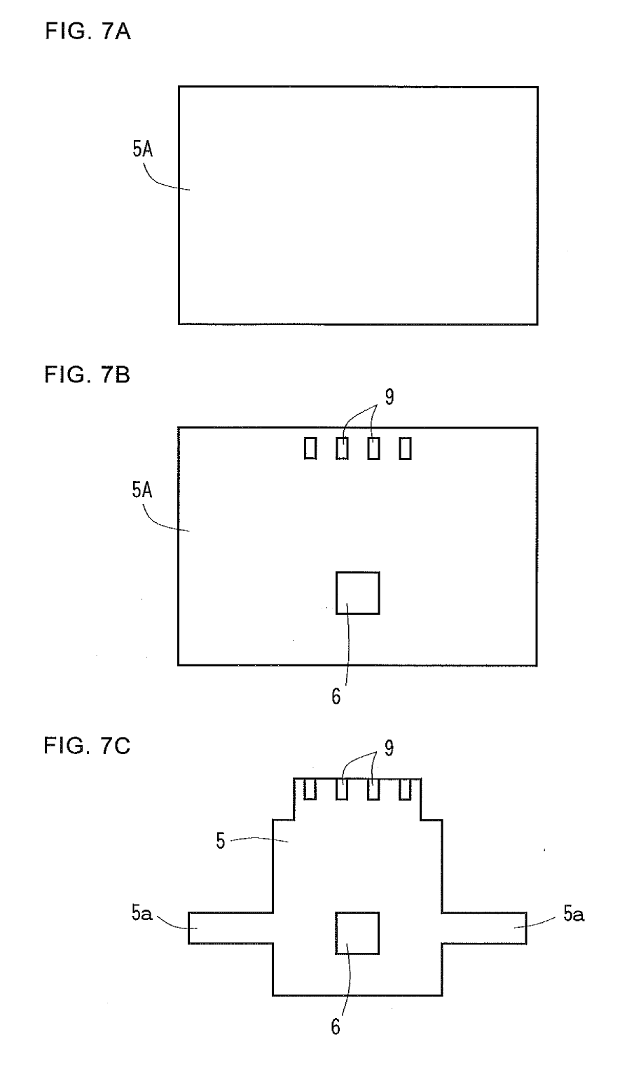

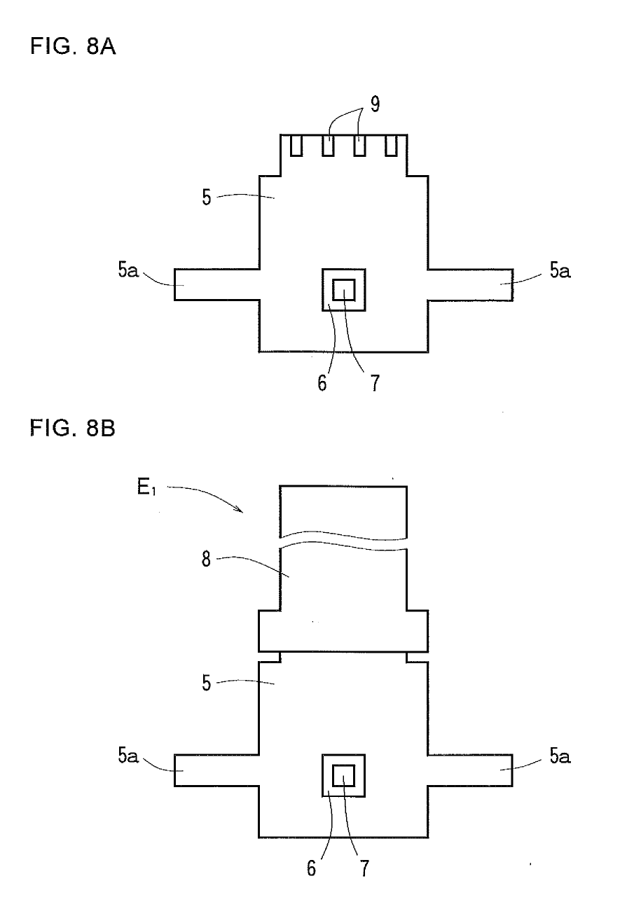

(2) The step of producing the aforementioned substrate unit E₁ (with reference to FIGS. 7A to 7C and FIGS. 8A and 8B).

(3) The step of coupling the aforementioned substrate unit E₁ to the aforementioned optical waveguide unit W₁.

The aforementioned step (1) of producing the optical waveguide unit W₁ will be described. First, a base 10 of a flat shape (with reference to FIG. 5A) for use in the manufacture of the aforementioned optical waveguide module for a touch panel is prepared. Examples of a material for the formation of the base 10 include glass, resins such as polycarbonate and polyethylene terephthalate, metal such as stainless steel, quartz, and silicon. The base 10 has a thickness, for example, in the range of 20 μm to 5 mm.

Then, as shown in FIG. 5A, the under cladding layer 2 is formed on a surface of the aforementioned base 10. Examples of a material for the formation of the under cladding layer 2 include a thermosetting resin and a photosensitive resin. When the aforementioned thermosetting resin is used, a varnish prepared by dissolving the thermosetting resin in a solvent is applied to the base 10 by a spin coating method, a dipping method, and the like, and a layer of the applied varnish is then heated to thereby form the under cladding layer 2. When the aforementioned photosensitive resin is used, on the other hand, a varnish prepared by dissolving the photosensitive resin in a solvent is applied to the base 10 in the aforementioned manner, and a layer of the applied varnish is then exposed to irradiation light such as ultraviolet light to thereby form the under cladding layer 2. The under cladding layer 2 has a thickness, for example, in the range of 25 to 300 μm.

Next, as shown in FIG. 5B, the cores 3A and 3B having a predetermined pattern are formed on a surface of the aforementioned under cladding layer 2 by a photolithographic method. Preferably, a photosensitive resin excellent in patterning characteristics is used as a material for the formation of the cores 3A and 3B. Examples of the photosensitive resin include UV-curable acrylic resins and UV-curable epoxy resins. These resins are used either singly or in combination. Examples of the sectional configuration of the cores 3A and 3B include a trapezoid and a rectangle having excellent patterning characteristics. The cores 3A and 3B have a width, for example, in the range of 10 to 100 μm, and a thickness (height), for example, in the range of 25 to 100 μm.

The material for the formation of the cores 3A and 3B used herein has a refractive index higher than that of the material for the formation of the under cladding layer 2 described above and the over cladding layer 4 to be described below (with reference to FIG. 2C). The adjustment of the refractive index may be made, for example, by adjusting the selection of the types of the materials for the formation of the aforementioned under cladding layer 2, the cores 3A and 3B and the over cladding layer 4, and the composition ratio thereof.

Then, as shown in FIG. 5C, a photosensitive resin to be formed into the over cladding layer 4 is applied to the surface of the under cladding layer 2 so as to cover the cores 3A and 3B to form a photosensitive resin layer (uncured) 4A. An example of the photosensitive resin to be formed into the over cladding layer 4 includes a photosensitive resin similar to that for the aforementioned under cladding layer 2.

Then, as shown in FIG. 5D, a mold 20 for press molding the over cladding layer 4 into the shape of the rectangular frame is prepared. This mold 20 is made of a material (for example, quartz) permeable to irradiation light such as ultraviolet light, and includes a cavity 21 having a mold surface complementary in shape to the surface of the aforementioned over cladding layer 4. This cavity 21 has ridge portions 21a for the formation of the aforementioned slots 4a (with reference to FIG. 2C), and curved surface portions 21b for the formation of the lens portions 40A and 40B (with reference to FIG. 2C).

Then, as shown in FIG. 6A, the mold 20 is pressed against the aforementioned photosensitive resin layer 4A so that the cavity 21 of the aforementioned mold 20 is positioned in a predetermined location relative to the aforementioned cores 3A and 3B, to mold the photosensitive resin layer 4A into the shape of the over cladding layer 4. Next, exposure to irradiation light such as ultraviolet light is performed through the aforementioned mold 20 in that state. Thereafter, a heating treatment is performed.

Thereafter, the mold is removed, as shown in FIG. 6B. This provides the over cladding layer 4 in the form of a rectangular frame which includes the slots 4a and the lens portions 40A and 40B. The thickness of the over cladding layer 4 (the thickness as measured from the surface of the under cladding layer 2) is generally 0.5 mm or more, preferably in the range of 0.5 to 2.0 mm. The depth of the aforementioned slots 4a is preferably 1.0 mm or more, as mentioned earlier.

Thereafter, as shown in FIG. 6C, the under cladding layer 2 together with the base 10 is cut into the shape of a rectangular frame by punching using a blade and the like. Then, the aforementioned base 10 is stripped from the under cladding layer 2. This provides the optical waveguide unit W₁ in the form of the rectangular frame which includes the under cladding layer 2, the cores 3A and 3B, and the over cladding layer 4. In this manner, the aforementioned step (1) of producing the optical waveguide unit W₁ is completed.

Thereafter, as shown in FIGS. 2A to 2C, the aforementioned optical waveguide unit W₁ is bonded to the surface of the base 1 that is an acrylic board or the like with an adhesive. At this time, the under cladding layer 2 is bonded to the aforementioned base 1. Thereafter, the notches la for the insertion of the lower end portions of the substrate units E₁ are formed in portions of the base 1 corresponding to the coupling positions of the substrate units E₁ (with reference to FIGS. 1A and 1B), with a puncher or the like. A base having no irregularities on the surface thereof is used as the aforementioned base 1. Examples of the base 1 include a polypropylene (PP) board, a metal plate, and a ceramic sheet, besides the aforementioned acrylic board. The thickness of the aforementioned base 1 is, for example, in the range of 500 μm to 5 mm.

Next, the aforementioned step (2) of producing the substrate unit E₁ will be described. First, an original plate 5A (with reference to FIG. 7A) serving as a base material for the aforementioned substrate 5 is prepared. Examples of a material for the formation of the original plate 5A include metal and resin. In particular, a stainless steel is preferably used from the viewpoint of easy machinability and dimensional stability. The thickness of the aforementioned original plate 5A is, for example, in the range of 0.02 to 0.1 mm.

Then, an insulation layer (not shown) is formed on a predetermined region of a surface of the aforementioned original plate 5A. An example of a method of forming this insulation layer includes applying a varnish prepared by dissolving a photosensitive resin such as a photosensitive polyimide resin and the like as a material in a solvent, and then performing exposure to irradiation light such as ultraviolet light and the like. The thickness of the insulation layer is generally in the range of 5 to 15 μm.

Next, as shown in FIG. 7B, connecting terminals 9 to the electrical interconnect line 8 for an optical element, the optical element mounting pad 6, and an electric circuit (not shown) are formed on a surface of the aforementioned insulation layer. The formation of these connecting terminals 9 and the like is achieved, for example, in a manner to be described below. Specifically, a metal layer (having a thickness on the order of 60 to 260 nm) is initially formed on the surface of the aforementioned insulation layer by sputtering, electroless plating and the like. This metal layer becomes a seed layer (a layer serving as a basis material for the formation of an electroplated layer) for a subsequent electroplating process. Then, a dry film resist is affixed to the opposite surfaces of a laminate comprised of the aforementioned original plate 5A, the insulation layer, and the seed layer. Thereafter, a photolithographic process is performed to form holes having the pattern of the aforementioned connecting terminals 9, the optical element mounting pad 6 and the electric circuit at the same time in the dry film resist on the side where the aforementioned seed layer is formed, so that a surface portion of the aforementioned seed layer is uncovered at the bottoms of the holes. Next, electroplating is performed to form an electroplated layer (having a thickness on the order of 5 to 20 μm) in a stacked manner on the surface portion of the aforementioned seed layer uncovered at the bottoms of the holes. Then, the aforementioned dry film resist is stripped away using an aqueous sodium hydroxide solution and the like. Thereafter, a seed layer portion on which the aforementioned electroplated layer is not formed is removed by soft etching, so that laminate portions comprised of the remaining electroplated layer and the underlying seed layer are formed into the aforementioned connecting terminals 9, the optical element mounting pad 6 and the electric circuit.

Then, as shown in FIG. 7C, the aforementioned original plate 5A is etched, so that unnecessary portions are removed. This provides the substrate 5 having the positioning plate portions 5a protruding in the direction of the width thereof.

Then, as shown in FIG. 8A, the optical element 7 is mounted on the mounting pad 6. Thereafter, the aforementioned optical element 7 and its surrounding portion are sealed with a transparent resin by potting (not shown).

Thereafter, as shown in FIG. 8B, the electrical interconnect line 8 for an optical element is connected to the aforementioned connecting terminals 9 (with reference to FIG. 8A). In this manner, the substrate unit E₁ is provided, and the aforementioned step (2) of producing the substrate unit E₁ is completed.

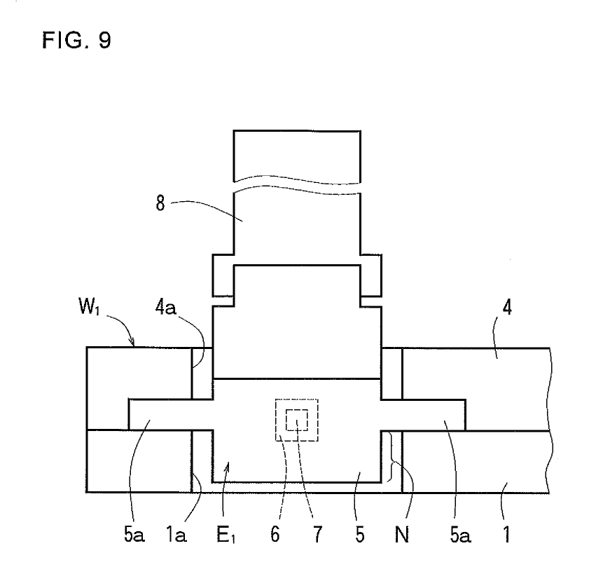

Next, the aforementioned step (3) of coupling the optical waveguide unit W₁ and the substrate unit E₁ together will be described. Specifically, as shown in FIG. 9, the substrate units E₁ is first positioned in a predetermined location of an outer edge portion of the optical waveguide unit W₁. At this time, the lower end portion N of the substrate unit E₁ is inserted into the notch 1a of the aforementioned base 1. At the same time, the lower end edges of the positioning plate portions 5a formed in the substrate unit E₁ are brought into abutment with the surface of the aforementioned base 1. Then, the aforementioned portions which are inserted and which are in abutment are fixed with an adhesive. Then, a portion of the substrate 5 of the substrate unit E₁ which lies above the optical element 7 is bent toward the aforementioned optical waveguide unit W₁, and the electrical interconnect line 8 extending from the distal end thereof is put into the slot 4a formed in the surface of the over cladding layer 4 (with reference to FIGS. 1B and 1C). In this manner, an intended optical waveguide module for a touch panel is completed. The optical waveguide module for a touch panel is disposed along the periphery of a display screen of a display of a touch panel.

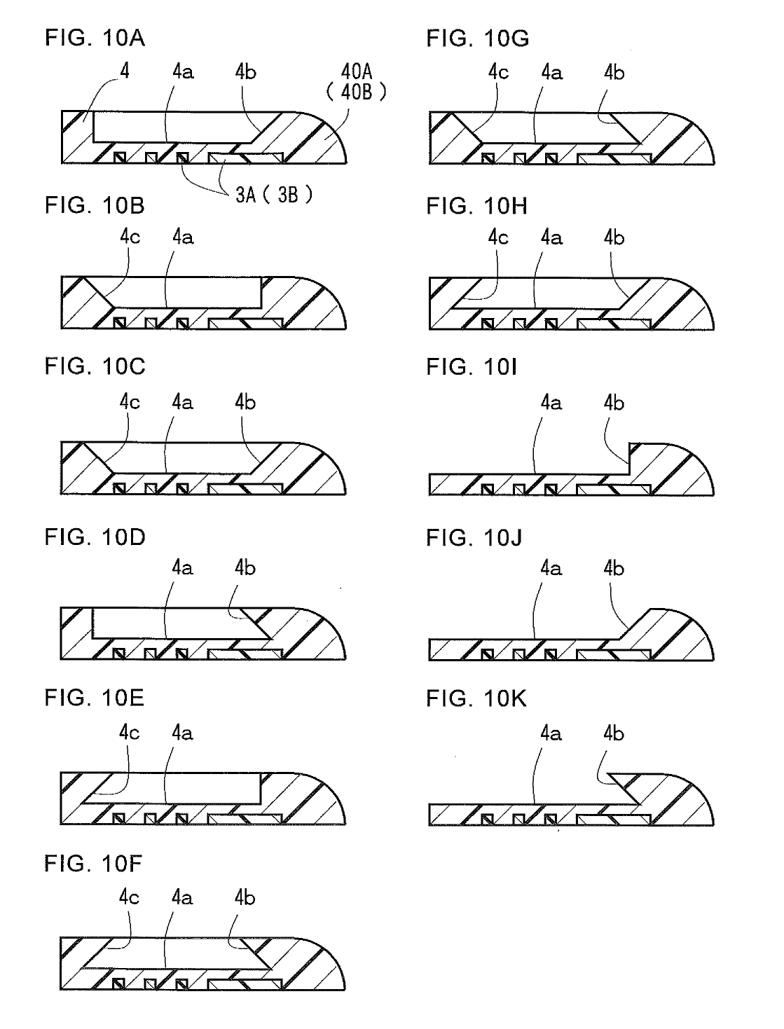

In the aforementioned preferred embodiment, the slots 4a formed in the surface of the over cladding layer 4 are of a generally U-shaped cross-sectional configuration having a flat bottom surface and wall surfaces orthogonal to the bottom surface on opposite sides of the bottom surface. The slots 4a, however, may be of other configurations. Examples of other configurations of the slots 4a are shown in FIGS. 10A to 10K. In these examples, the slots 4a have a flat bottom surface as in the aforementioned preferred embodiment, but are configured such that at least one of the opposite wall surfaces 4b and 4c is inclined (with reference to FIGS. 10A to 10H) or such that the side wall corresponding to the outer periphery of the optical waveguide unit W₁ (on the opposite side from the lens portions 40A and 40B) is dispensed with (with reference to FIGS. 10I to 10K). In FIGS. 10A to 10K, only the cores 3A and 3B and the over cladding layer 4 (including the lens portions 40A and 40B) are shown, but the under cladding layer 2 and the base 10 (with reference to FIG. 6C) are not shown.

Specifically, in FIG. 10A, the wall surface 4b on the side of the lens portions 40A and 40B is formed as an inclined surface such that the opening width of the slot 4a becomes greater. In FIG. 10B, the wall surface 4c on the opposite side from the lens portions 40A and 40B is formed as an inclined surface such that the opening width of the slot 4a becomes greater. In FIG. 10C, the wall surfaces 4b and 4c on both sides are formed as inclined surfaces such that the opening width of the slot 4a becomes greater. The slots 4a of such configurations are able to easily receive the electrical interconnect line 8 (with reference to FIG. 1C).

In FIG. 10D, the wall surface 4b on the side of the lens portions 40A and 40B is formed as an inclined surface such that the opening width of the slot 4a becomes smaller. In FIG. 10E, the wall surface 4c on the opposite side from the lens portions 40A and 40 is formed as an inclined surface such that the opening width of the slot 4a becomes smaller. In FIG. 10F, the wall surfaces 4b and 4c on both sides are formed as inclined surfaces such that the opening width of the slot 4a becomes smaller. The slots 4a of such configurations make it difficult for the electrical interconnect line 8 received therein to come off to the outside.

Further, in FIG. 10G, the wall surfaces 4b and 4c on both sides are formed as parallel inclined surfaces extending in an upward direction away from the lens portions 40A and 40B. In FIG. 10H, the wall surfaces 4b and 4c on both sides are formed as parallel inclined surfaces inclined in a direction opposite from the direction shown in FIG. 10G. The slots 4a of such configurations allow the electrical interconnect line 8 to be put thereinto in an oblique direction.

In FIGS. 10I to 10K, the side wall corresponding to the opposite side from the lens portions 40A and 40B is dispensed with. Among these, in FIG. 10I, the wall surface 4b on the side of the lens portions 40A and 40B is orthogonal to the bottom surface. In FIG. 10J, the wall surface 4b on the side of the lens portions 40A and 40B is formed as an inclined surface extending in an upward direction toward the lens portions 40A and 40B. In FIG. 10K, the wall surface 4b on the side of the lens portions 40A and 40B is formed as an inclined surface extending in an upward direction away from the lens portions 40A and 40B. The slots 4a of such configurations allow the electrical interconnect line 8 to be put thereinto in a sidewise direction opposite from the lens portions 40A and 40B.

Also, in the aforementioned preferred embodiment, the slots 4a of the over cladding layer 4 are formed by molding at the same time as the over cladding layer 4. However, the aforementioned slots 4a may be formed by removing part of the surface of the over cladding layer 4 after the over cladding layer 4 is formed. Examples of the method of the aforementioned removal include grinding, cutting, laser processing, and etching.

Further, in the aforementioned preferred embodiment, the lens portions 40A and 40B are formed in the over cladding layer 4 of the optical waveguide unit W₁. However, the lens portions 40A and 40B need not be formed, but the over cladding layer 4 may have a flat edge surface. In such a case, it is preferable that a lens element is provided as a separate component.

Next, inventive examples of the present invention will be described in conjunction with a conventional example. It should be noted that the present invention is not limited to the inventive examples.

### EXAMPLES

### Inventive Examples 1 to 12

### Optical Waveguide Unit

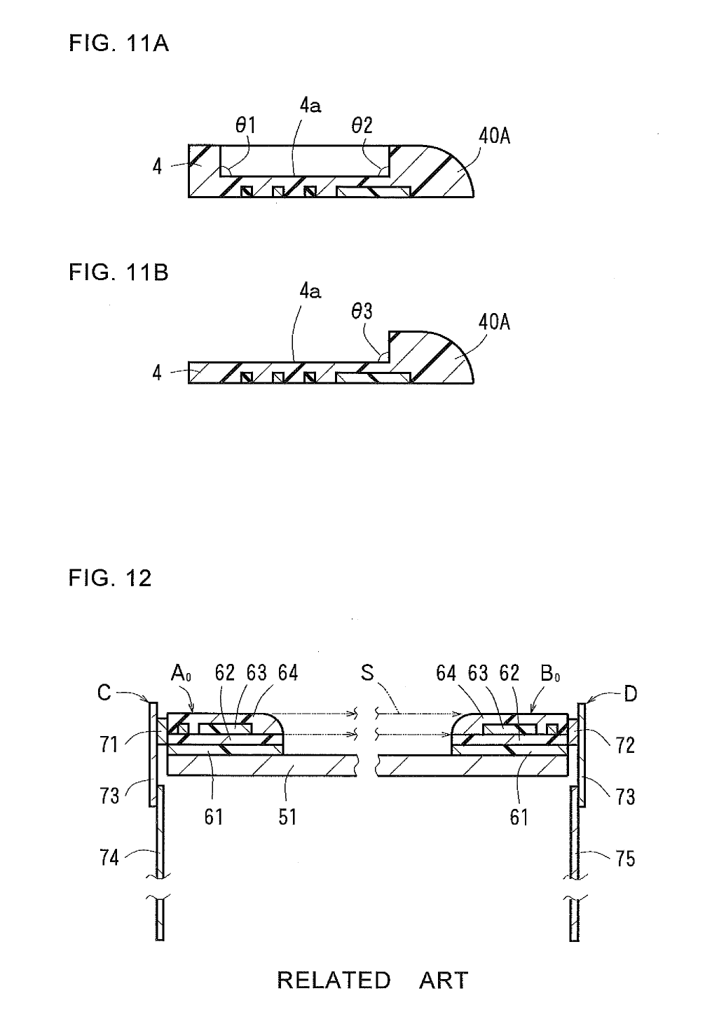

An optical waveguide unit including an over cladding layer 4 of a cross-sectional configuration shown in FIG. 11A or 11B was produced. In all Inventive Examples 1 to 12, the thickness of the over cladding layer 4 (the thickness as measured from a surface of an under cladding layer) was 1 mm, the depth of a slot 4a was 0.3 mm, and the radius of curvature of the lens portions 40A was 1.5 mm. The slot 4a was produced so that the wall surface thereof had different angles (θ1, θ2 and θ3), as indicated in Table 1 below.

### Substrate Unit

A substrate unit in which an electrical interconnect line (having a thickness of 0.2 mm) extended from an upper end portion of a substrate was produced.

### Optical Waveguide Module for Touch Panel

The aforementioned substrate unit was coupled to the aforementioned optical waveguide unit. The substrate in the substrate unit was bent, and the electrical interconnect line was put into the slot of the optical waveguide unit.

### Conventional Example

### Optical Waveguide Unit

An optical waveguide unit in which the aforementioned slot was not formed in an over cladding layer was produced. Except for this difference, Conventional Example was similar to Inventive Examples 1 to 12 described above.

### Substrate Unit

A substrate unit in which an electrical interconnect line extended from an bottom end portion of a substrate was produced.

### Optical Waveguide Module for Touch Panel

The aforementioned substrate unit was coupled to the aforementioned optical waveguide unit. There was no place to put the electrical interconnect line of the substrate unit. The electrical interconnect line was hung down (with reference to FIG. 12).

### Measurement of Thickness

In Inventive Examples 1 to 12, the thickness of a portion of the optical waveguide module for a touch panel which is above the surface of the under cladding layer was measured with a contact-type thickness gauge, and the result was listed in Table 1 below. It was immediately apparent that the thickness in Conventional Example was greater than that in Inventive Examples 1 to 12. Therefore, the thickness in Conventional Example was not measured.

TABLE 1

| | | Angle of Wall | | | |
|---|---|---|---|---|---|
| | Figure of | Surface of Slot | | | |
| | Slot | θ1 | θ2 | θ3 | Thickness |
| Inv. Ex. 1 | FIG. | 90° | 90° | — | 1 mm |
| Inv. Ex. 2 | 11A | 90° | 120° | — | 1 mm |
| Inv. Ex. 3 | | 120° | 90° | — | 1 mm |
| Inv. Ex. 4 | | 120° | 120° | — | 1 mm |
| Inv. Ex. 5 | | 90° | 60° | — | 1 mm |
| Inv. Ex. 6 | | 60° | 90° | — | 1 mm |
| Inv. Ex. 7 | | 60° | 60° | — | 1 mm |
| Inv. Ex. 8 | | 120° | 60° | — | 1 mm |
| Inv. Ex. 9 | | 60° | 120° | — | 1 mm |
| Inv. Ex. | FIG. | — | — | 90° | 1 mm |
| 10 | 11B | | | | |
| Inv. Ex. | | — | — | 120° | 1 mm |
| 11 | | | | | |
| Inv. Ex. | | — | — | 60° | 1 mm |
| 12 | | | | | |

The result in Table 1 above shows that the measurement values of the thickness in Inventive Examples 1 to 12 do not exceed the thickness of the over cladding layer, which produces the effect of space savings.

The optical waveguide module for a touch panel is applicable to an optical waveguide for use as a detection means (a position sensor) for detecting a finger touch position and the like in a touch panel.

Although specific forms of embodiments of the instant invention have been described above and illustrated in the accompanying drawings in order to be more clearly understood, the above description is made by way of example and not as a limitation to the scope of the instant invention. It is contemplated that various modifications apparent to one of ordinary skill in the art could be made without departing from the scope of the invention.

What is claimed is:

1. An optical waveguide module for a touch panel, comprising:
an optical waveguide unit for placement along the periphery of a display screen of a display of a touch panel; and
a substrate unit coupled to an outer edge portion of the optical waveguide unit so as to be in orthogonal relation to the optical waveguide unit,
wherein the optical waveguide unit includes an under cladding layer, cores provided on a surface of the under cladding layer, and an over cladding layer provided to cover the cores,
wherein the substrate unit includes a substrate, an optical element mounted on a surface of the substrate, and an electrical interconnect line for an optical element connected to the substrate,
wherein the substrate of the substrate unit is bent toward the optical waveguide unit,
wherein the bend of the substrate has a distal end serving as a connecting portion to the electrical interconnect line,
wherein the over cladding layer includes a slot provided in a surface thereof and extending along the periphery of the display screen of the display, and
wherein the electrical interconnect line is put in the slot provided in the surface of the over cladding layer.

2. The optical waveguide module for a touch panel according to claim 1, wherein the slot has a depth of not less than 0.1 mm.

3. The optical waveguide module for a touch panel according to claim 1, wherein an inner edge portion of the over cladding layer for positioning on the periphery of the display screen of the display is in the form of a lens portion having an outwardly-bulging arcuately curved surface as seen in vertical sectional view.

4. The optical waveguide module for a touch panel according to claim 2, wherein an inner edge portion of the over cladding layer for positioning on the periphery of the display screen of the display is in the form of a lens portion having an outwardly-bulging arcuately curved surface as seen in vertical sectional view.

5. A method of manufacturing an optical waveguide module for a touch panel, comprising:
producing an optical waveguide unit;
producing a substrate unit separately from the optical waveguide unit; and
coupling the substrate unit to an outer edge portion of the optical waveguide unit,
wherein producing the optical waveguide unit includes:
forming cores on a surface of an under cladding layer, and then
forming a slot for receiving an electrical interconnect line of the substrate unit therein in a surface of an over cladding layer by molding at the same time as the formation of the over cladding layer covering the cores,
wherein coupling the substrate unit to the optical waveguide unit is performed while a substrate of the substrate unit is bent toward the optical waveguide unit and the electrical interconnect line connected to a distal end of the bend of the substrate is put in the slot.

6. A method of manufacturing an optical waveguide module for a touch panel, comprising:
producing an optical waveguide unit;
producing a substrate unit separately from the optical waveguide unit; and
coupling the substrate unit to an outer edge portion of the optical waveguide unit,
wherein producing the optical waveguide unit includes:
forming cores on a surface of an under cladding layer,
forming an over cladding layer covering the cores, and then
removing part of a surface of the over cladding layer to form a slot for receiving an electrical interconnect line of the substrate unit therein,
wherein coupling the substrate unit to the optical waveguide unit is performed while a substrate of the substrate unit is bent toward the optical waveguide unit and the electrical interconnect line connected to a distal end of the bend of the substrate is put in the slot.

7. The method of manufacturing an optical waveguide module for a touch panel according to claim 5, wherein the slot has a depth of not less than 0.1 mm.

8. The method of manufacturing an optical waveguide module for a touch panel according to claim 6, wherein the slot has a depth of not less than 0.1 mm.

9. The method of manufacturing an optical waveguide module for a touch panel according to claim 5, wherein an inner edge portion of the over cladding layer for positioning on the periphery of a display screen of a display is formed as a lens portion having an outwardly-bulging arcuately curved surface as seen in vertical sectional view when the over cladding layer is formed.

10. The method of manufacturing an optical waveguide module for a touch panel according to claim 6, wherein an inner edge portion of the over cladding layer for positioning on the periphery of a display screen of a display is formed as a lens portion having an outwardly-bulging arcuately curved surface as seen in vertical sectional view when the over cladding layer is formed.

11. The method of manufacturing an optical waveguide module for a touch panel according to claim 7, wherein an inner edge portion of the over cladding layer for positioning on the periphery of a display screen of a display is formed as a lens portion having an outwardly-bulging arcuately curved surface as seen in vertical sectional view when the over cladding layer is formed.

12. The method of manufacturing an optical waveguide module for a touch panel according to claim 8, wherein an inner edge portion of the over cladding layer for positioning on the periphery of a display screen of a display is formed as a lens portion having an outwardly-bulging arcuately curved surface as seen in vertical sectional view when the over cladding layer is formed.
